(19) United States
(12) Patent Application Publication
(10) Pub. No.: US 2006/0230241 A1
(43) Pub. Date: Oct. 12, 2006

(54) Buffer architecture for data organization

(76) Inventors: Kalpesh D. Mehta, Chandler, AZ (US); Amit S. Agrawal, Chandler, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/094,771

(22) Filed: Mar. 30, 2005

(51) Int. Cl. G06F 13/00

(52) U.S. Cl. 711/154

(57) ABSTRACT

An embodiment includes an apparatus that includes a first data processor component to output data in a first data organization. The apparatus also includes a data storage logic to receive the data output from the first data processor component. The data storage logic is to rearrange the data into a second data organization prior to storage of the data into a data storage. The second data organization is a native format of a second data processor component to subsequently process the data.

### TECHNICAL FIELD

The application relates generally to data processing, and, more particularly, to a buffer architecture for data organization.

### BACKGROUND

Data storage is relevant to a number of different applications. One exemplary application relates to a decoding operation. In particular, a number of different components may be used to perform different parts of the decoding operation. Data is typically transferred between such components using different types of data buffers. Moreover, these different components may output and process the data in different types of formats.

### BRIEF DESCRIPTION OF THE DRAWING

Embodiments of the invention may be best understood by referring to the following description and accompanying drawing that illustrate such embodiments. The numbering scheme for the Figures included herein is such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a block diagram of a decoder, according to some embodiments of the invention.

FIG. 2 illustrates a more detailed block diagram of data storage and logic, according to some embodiments of the invention.

FIG. 3 illustrates a more detailed block diagram of data storage and logic, according to some embodiments of the invention.

FIGS. 4A-4D illustrate different data organizations or formats of data, according to some embodiments of the invention.

FIG. 5 illustrates a flow diagram for data organization, according to some embodiments of the invention.

FIG. 6 illustrates a processor architecture that includes the buffer configuration for decoding operations, according to some embodiments of the invention.

### DETAILED DESCRIPTION

Embodiments of the invention are described in reference to a video decoding operation. However, embodiments are not so limited. Embodiments may be used in any of a number of different applications (encoding operations, etc.). In particular, embodiments may be used in any application wherein different components exchange data through some type of data storage/storage medium.

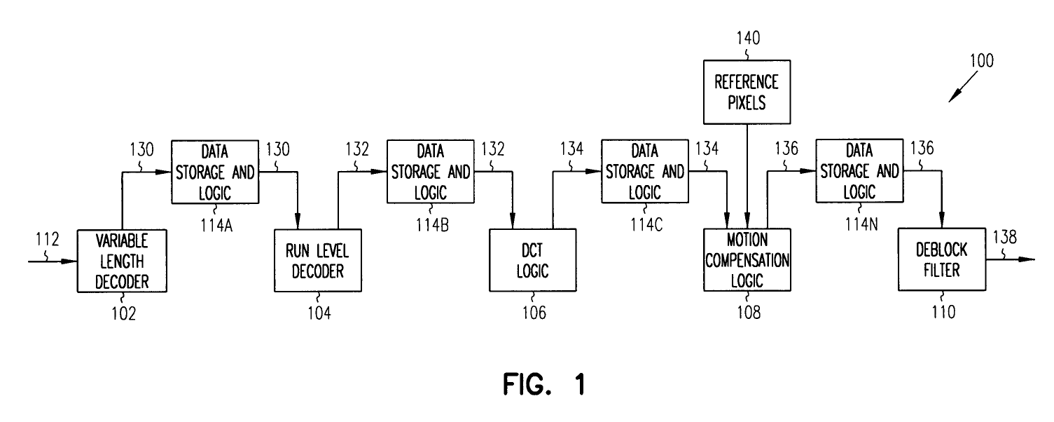

FIG. 1 illustrates a block diagram of a video decoder, according to some embodiments of the invention. In particular, FIG. 1 illustrates a system 100 that includes a variable length decoder 102, a run level decoder 104, a Discrete Cosine Transform (DCT) logic 106, a motion compensation logic 108, a deblock filter 110 and data storage and logic 114A-114N. The variable length decoder 102, the run level decoder 104, the DCT logic 106, the motion compensation logic 108 and the deblock filter 110 may be representative of hardware, software, firmware or a combination thereof. In some embodiments, the different components (the variable length decoder 102, the run level decoder 104, the DCT logic 106, the motion compensation logic 108 and the deblock filter 110) may generate and process the data according to different formats and data organizations. Accordingly, as further described below, in some embodiments, the data storage and logic 114 may rearrange the data based on the type of format/data organization that is native to a given component. Therefore, some embodiments allow these different components not to consume processing bandwidth on operations related to rearrangement of data.

The data storage and logic 114A-114N may include different types of machine-readable medium. For example, the machine-readable medium may be volatile media (e.g., random access memory (RAM), magnetic disk storage media, optical storage media, flash memory devices, etc.). The machine-readable medium may be different types of RAM (e.g., Synchronous Dynamic RAM (SDRAM), DRAM, Double Data Rate (DDR)-SDRAM, etc.).

The variable length decoder 102 is coupled to receive a compressed bit stream 112. In some embodiments, the compressed bit stream may be encoded data that is coded based on any of a number of different decoding standards. Examples of the different coding standards include Motion Picture Experts Group (MPEG)-2, MPEG-4, Windows Media (WM)-9, etc. For more information regarding various MPEG-2 standards, please refer to “International Organization for Standardization (ISO)/International Electrotechnical Commission (IEC) 13818-2:2000 Information Technology—Generic Coding of Moving Pictures and Associated Audio Information: Video” and related amendments. For more information regarding various MPEG-4 standards, please refer to “ISO/IEC 14496 Coding of Audio-Visual Objects—Part 2: Video” and related amendments. A more detailed description of the packets 114 and the generation thereof by the variable length decoder 102 is set forth below.

The variable length decoder 102 may generate macroblock packets 130 based on the compressed bit stream 112. The variable length decoder 102 is coupled to store the macroblock packets 130 into the data storage and logic 114A.

The run level decoder 104 is coupled to receive the macroblock packets 130 from the data storage and logic 114A. The run level decoder 104 may generate coefficient data 132 based on the macroblock packets 130. The run level decoder 104 is coupled to store the coefficient data 132 into the data storage and logic 114B. The DCT logic 106 is coupled to receive the coefficient data 132 from the data storage and logic 114B. The DCT logic 106 may generate pixels 134 based on the coefficient data 132. For example, the DCT logic 106 may generate pixels for I-frames or residues for the P-frames. The DCT logic 106 is coupled to store the pixels 134 into the data storage and logic 114C.

The motion compensation logic 108 is coupled to receive the pixels 134 from the data storage and logic 1 14C and to receive reference pixels 140. The motion compensation logic 108 may generate pel data 136 based on the pixels 134 and the reference pixels 140. The motion compensation logic 108 is coupled to store the pel data 136 into the data storage and logic 114N. The deblock filter 112 is coupled to receive the pel data 136 from the data storage and logic 114N. The deblock filter 112 may generate pel output 122 based on the pel data 136.

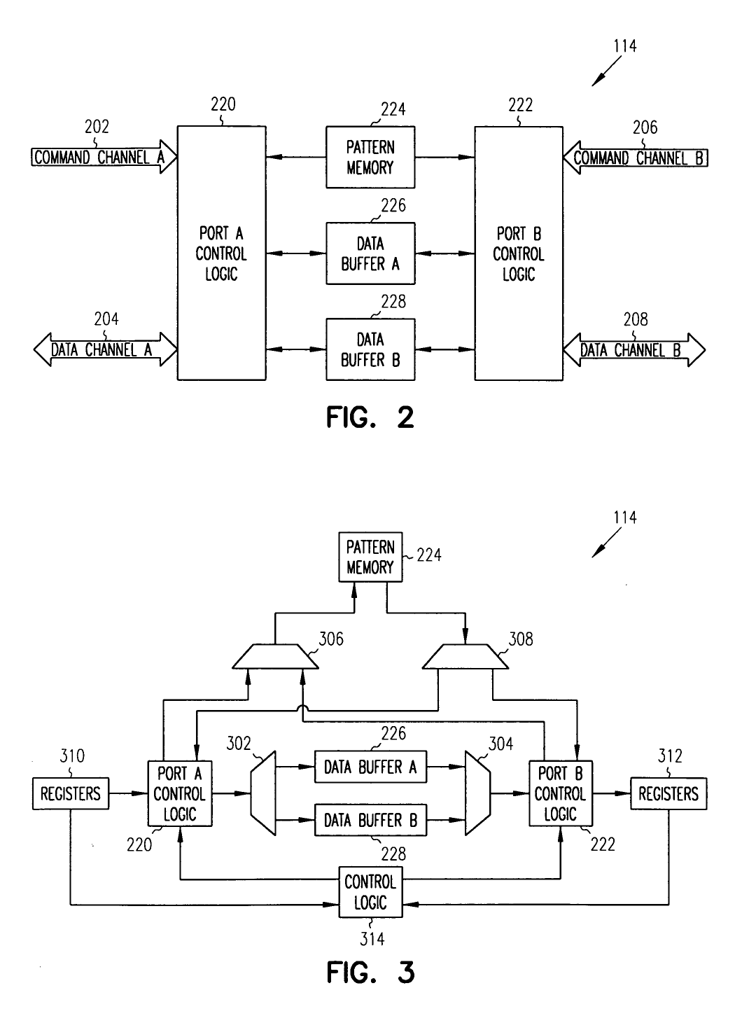

A more detailed description of the data storage and logic 114 is now set forth. In particular, FIG. 2 illustrates a more detailed block diagram of data storage and logic, according to some embodiments of the invention. The data storage and logic 114 includes two ports and two data buffers. In particular, the data storage and logic 114 includes a port A control logic 220 and a port B control logic 222. The port A control logic 220 is coupled to receive control commands through a command channel A 202. The port A control logic 220 is also coupled to transmit and receive data through a data channel A 204. The port B control logic 222B is coupled to receive control commands through a command channel B 206. The port B control logic 222 is also coupled to transmit and receive data through a data channel B 208. The port A control logic 220 and the port B control logic 222 may be representative of hardware, software, firmware or a combination thereof.

The data storage and logic 114 includes a pattern memory 224, a data buffer A 226 and a data buffer B 228. The pattern memory 224, the data buffer A 226 and the data buffer B 228 may be different types of machine-readable medium (as described above). The pattern memory 224, the data buffer A 226 and the data buffer B 228 may be part of a same or different machine-readable mediums. The port A control logic 220 and the port B control logic 222 may control the reading and writing of data from and to the data buffer A 226 and the data buffer B 228.

Through the command channel A 202 and the data channel A 204, the port A control logic 220 may be coupled to a first data processor component. Through the command channel B 206 and the data channel B 204, the port B control logic 222 may be coupled to a second data processor component. In particular, the first data processor component may output data, wherein the port A control logic 220 stores such data in the data buffer A 226 or the data buffer B 228. The port B control logic 222 may retrieve this data for further processing by the second data processor component.

In some embodiments, the operations of the port A control logic 220 and the port B control logic 222 may be based on a ping-pong type operation. The port A control logic 220 may write data into either the data buffer A 226 or the data buffer B 228, while the port B control logic 222 may be reading data from the other one. In other words, in some embodiments, data cannot be read from the data buffer A 226 and the data buffer B 228 while data is being written thereto.

Referring back to FIG. 1, the data processor components may be the variable length decoder 102, the run level decoder 104, the DCT logic 106, the motion compensation logic 108 or the deblock filter 110. For example, for the data storage and logic 1 14A, the port A control logic 220 and the port B control logic 222 are coupled, respectively, to the variable length decoder 102 and the run level decoder 104. For the data storage and logic 114B, the port A control logic 220 and the port B control logic 222 are coupled, respectively, to the run level decoder 104 and the DCT logic 106. For the data storage and logic 1 14C, the port A control logic 220 and the port B control logic 222 are coupled, respectively, to the DCT logic 106 and the motion compensation logic 108. For the data storage and logic 114N, the port A control logic 220 and the port B control logic 222 are coupled, respectively, to the motion compensation logic 108 and the deblock filter 110.

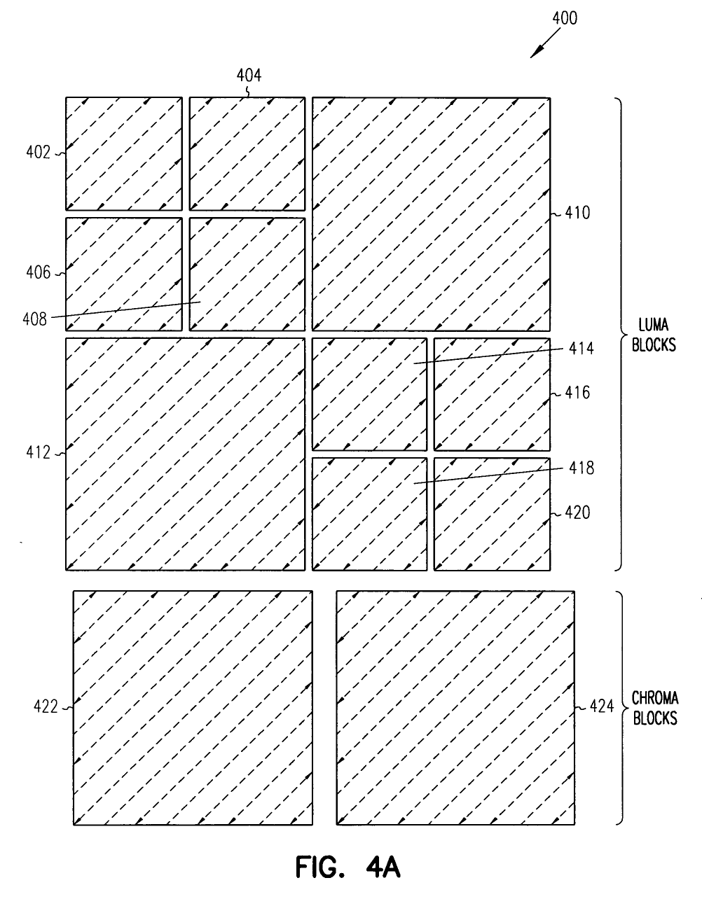

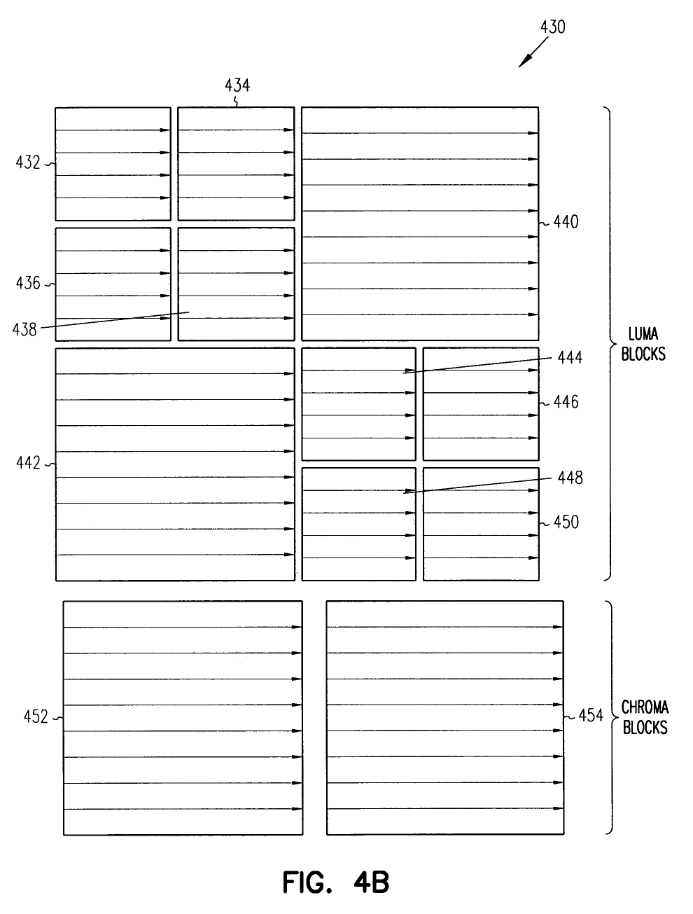

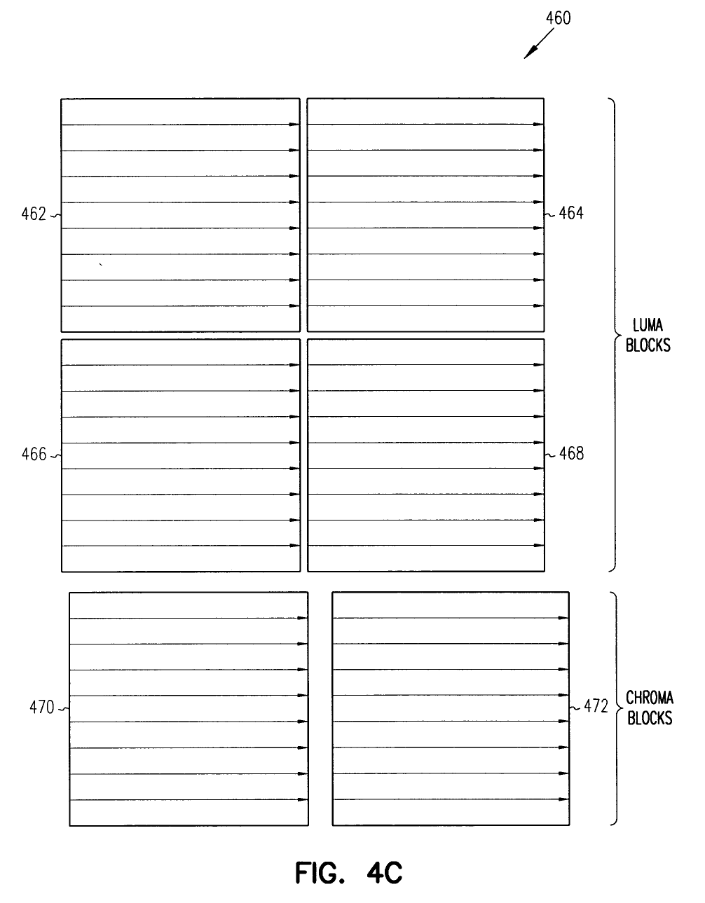

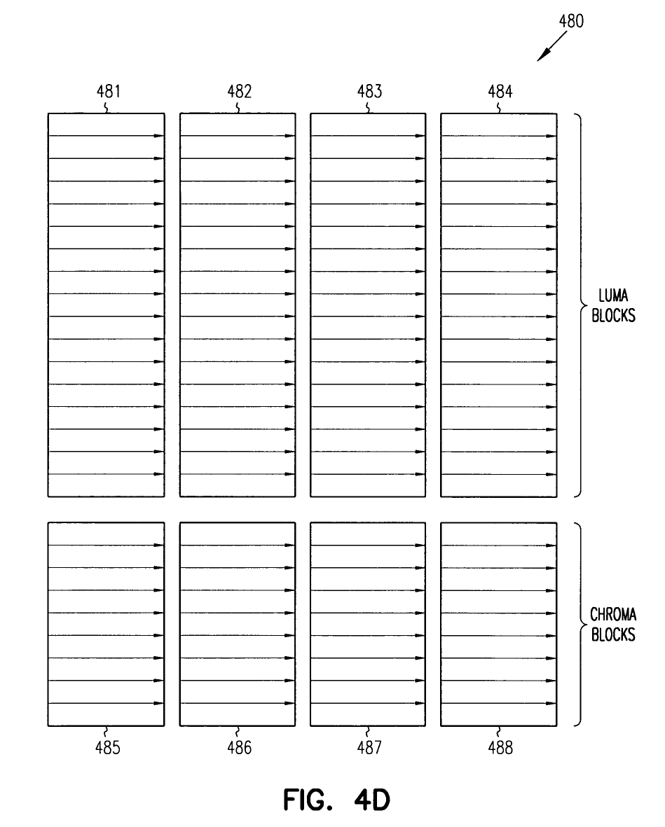

The port A control logic 220 may store the data into the data buffer A 226 and the data buffer B 228 using a number of different organization types. For example, in some embodiments, the data buffer A 226 and the data buffer 228 may be partitioned into any of a number of different blocks. The port A control logic 220 may store data into the different blocks in different order. Examples of the type of order may be row wise, column wise, zigzag, random, etc. In some embodiments, the port A control logic 220 may store the data into the data buffer A 226 or the data buffer B 228 based the patterns stored in the pattern memory 224. In some embodiments, the port A control logic 220 may receive data from a first data processor component, which is of a first data organization. For example, the data may be in a native format for the first processor component. The port A control logic 220 may rearrange the received data such that the data is stored in a second data organization. For example, the data may be rearranged to be stored in a native format for the second processor component. Accordingly, the port B control logic 222 may retrieve the data (which is in a native format for the second data processor component) for processing by the second data processor component. Therefore, neither the first data processor component nor the second data processor component needs to rearrange the data prior to processing by the second processor component. A more detailed description of different data organizations is set forth below in conjunction with FIGS. 4A-4D.

FIG. 3 illustrates a more detailed block diagram of data storage and logic, according to some embodiments of the invention. The data storage and logic 114 includes logic to allow one of the control logics to write data into one of the data buffers, while allowing the other one of the control logics to read data from the other one of the data buffers. The logic allows these operations to be switched such that the writing control logic is writing to the one of the data buffers and the reading control logic is reading from the other one.

The data storage and logic 114 includes a control logic 314 that is coupled to read data from registers 310 and registers 312. The registers 310 may be representative of the command channel A 202 and the data channel A 204. The registers 312 may be representative of the command channel B 206 and the data channel B 208. The port A control logic 220 is coupled to read data from the registers 310. The port B control logic 220 is coupled to write data to the registers 312. Returning to FIG. 1 to help illustrate, the variable length decoder 102 may write different data and control information to the registers 310. The run level decoder 104 may read data from the registers 312.

A first output of the control logic 314 is coupled to a first input of the port A control logic 220. A second output of the control logic 314 is coupled to a first input of the port B control logic 222. A first output of the port A control logic 220 is coupled to an input of a multiplexer 302. A first output of the multiplexer 302 is coupled to an input of the data buffer A 226, and a second output of the multiplexer 302 is coupled an input of the data buffer B 228. An output of the data buffer A 226 is coupled to a first input of a multiplexer 304. An output of the data buffer B 228 is coupled to a second input of the multiplexer 304. An output of the multiplexer 304 is coupled to a second input of the port B control logic 222.

A second output of the port A control logic 220 is coupled to a first input of a multiplexer 306. A second output of the port B control logic 222 is coupled to a second input of the multiplexer 306. An output of the multiplexer 306 is coupled to an input of the pattern memory 224. An output of the pattern memory 224 is coupled to an input of a multiplexer 308. A first output of the multiplexer 308 is coupled to a second input of the port A control logic 220. A second output of the multiplexer 308 is coupled to a second input of the port B control logic 222.

The port A control logic 220 and the port B control logic 222 may write and read to the pattern memory 224 through the multiplexer 306 and the multiplexer 308, respectively. For example, the port A control logic 220 or the port B control logic 222 may read the pattern stored in the pattern memory 224 to determine how to write to and read data from the data buffer A 226 and the data buffer B 228. Moreover, the port A control logic 220 or the port B control logic 222 may store a pattern in the pattern memory 224. The port A control logic 220 may write to the data buffer A 226 and the data buffer B 228 through the multiplexer 302. The port A control logic 222 may read from the data buffer A 226 and the data buffer B 228 through the multiplexer 304.

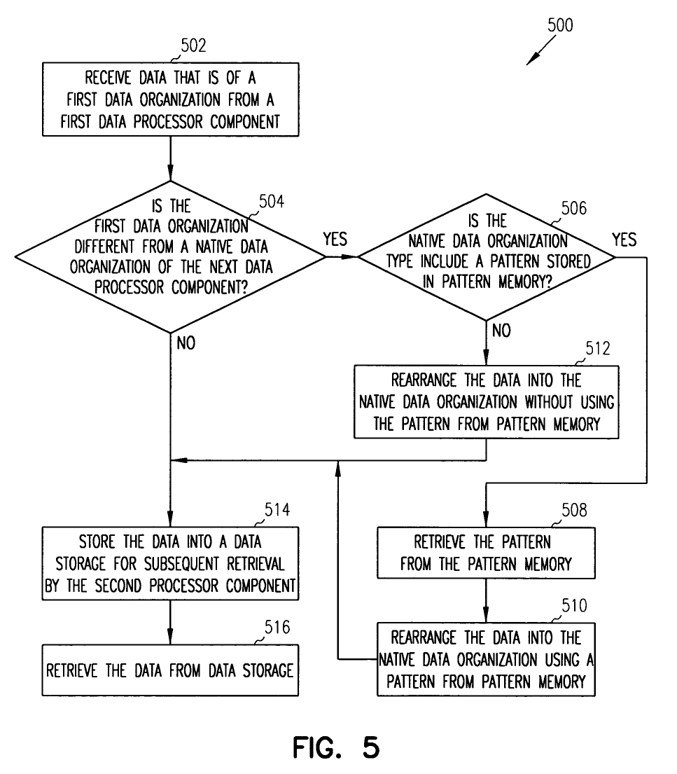

The control logic 314 may control the operations of the port A control logic 220 and the port B control logic 222. For example, the control logic 314 may cause the port A control logic 220 to write to the data buffer 226 based on the pattern stored in the pattern memory 224 for a given time period. The control logic 314 may cause the port B control logic 222 to read from the data buffer 228 in a given order for the same time period. A more detailed description of the operations of the data storage and logic 114 is set forth below in conjunction with FIG. 5.

While illustrated such that port A is the write port and port B is the read port, embodiments are not so limited. For example, the port A may be the read port and port B may be the write port. Moreover, in some embodiments, the port A and the port B may be read/write ports. Accordingly, the arrows in FIG. 3 showing data flow from left to right may be bi-directional.

While illustrated to include a data storage and logic with two ports, embodiments are not so limited. In some embodiments, the system 100 may include a lesser or greater number of the data storage and logic 114. For example, the system 100 may include only one of the data storage and logic 114, which includes ports for the different data processor components. Accordingly, referring to FIG. 1, the system 100 would include one data storage and logic 114 with eight different ports. In particular, the data storage and logic 114 would include one port each for the variable length decoder 102 and the deblock filter 114. The data storage and logic 114 would also include two ports each for the run level decoder 104, the DCT logic 106 and the motion compensation logic 108.

FIGS. 4A-4D illustrate different data organizations or formats of data, according to some embodiments of the invention. In particular, FIGS. 4A-4D illustrate different data organizations or formats of data stored in the data buffer A 226 and the data buffer B 228. FIGS. 4A-4D are described for storage of video pixels as part of decoding operations. However, the data organizations and formats may be used for any other type of data.

FIG. 4A illustrates a data organization 400 for a macroblock of data that includes blocks 402-424. The blocks 402-424 are blocks of data storage of different sizes. The block size of the blocks 402-408 is 4×4 (thereby storing 16 pixels of data). The size of the blocks 410, 412, 422 and 424 is 8×8 (thereby storing 64 pixels of data). All of the blocks 402-424 have a IZZ pattern for the storage of data. The data is stored in an order such that the block 402 is filled with data, followed by the block 404, followed by the block 406, etc. until the block 424 is filled with data. Moreover, the data is stored in the blocks 402-424 by following the arrows from beginning to the pointed end of the arrow. In particular, the data is stored in a diagonal fashion starting at the tope and traversing down. As shown, in some embodiments, the data stored in the blocks 402-420 and the data stored in the blocks 422-424 are luma data and chroma data of a video stream, respectively.

FIG. 4B illustrates a data organization 430 for a macroblock of data that includes blocks 432-454. The blocks 432-454 are blocks of data storage of different sizes. The block size of the blocks 432-438 and the blocks 444-450 is 4×4. The block size of the blocks 440-442 and 452-454 is 8×8. All of the blocks 432-454 have a row wise pattern for the storage of data. The data is stored in an order such that the block 432 is filled with data, followed by the block 434, followed by the block 436, etc. until the block 454 is filled with data. Moreover, the data is stored in the blocks 432-454 in a raster scan order (left to right, top to bottom). As shown, in some embodiments, the data stored in the blocks 432-450 and the data stored in the blocks 452-454 are luma data and chroma data of a video stream, respectively.

FIG. 4C illustrates another variant of data organization. FIG. 4C illustrates a data organization 460 for a macroblock of data that includes blocks 462-472. The block size of all of the blocks 462-472 is 8×8. All of the blocks 462-472 have a row wise pattern for the storage of data. The data is stored in an order such that the block 462 is filled with data, followed by the block 464, followed by the block 466, followed by the block 468, followed by the block 470 and followed by the block 472. As shown, in some embodiments, the data stored in the blocks 462-468 and the data stored in the blocks 470-472 are luma data and chroma data of a video stream, respectively.

FIG. 4D illustrates another variant of data organization. In particular, FIG. 4D illustrates a data organization 480 for a macroblock of data that includes a raster scan pattern with a column mode four pixels at a time. The data organization 480 for the macroblock of data includes blocks 481-488. The block size of the blocks 481-484 is 4×16 (thereby storing 64 pixels of data). The block size of the blocks 485, 486, 487 and 488 is 4×8 (thereby storing 32 pixels of data). The data is stored in an order such that the block 481 is filled with data, followed by the block 482, followed by the block 483, etc. until the block 488 is filled with data. Moreover, the data is stored in the blocks 481-488 by following the arrows from beginning to the pointed end of the arrow. As shown, in some embodiments, the data stored in the blocks 481-484 and the data stored in the blocks 485-488 are luma data and chroma data of a video stream, respectively.

Embodiments are not limited to the data organizations shown in FIGS. 4A-4D. A variant of data organization may include other block sizes (e.g., 16×16). Another variant may include different patterns within the different blocks. For example, with reference to FIG. 4C, the block 462 may be a row wise pattern, while the blocks 464-472 may be a zigzag pattern.

FIG. 5 illustrates a flow diagram for data organization, according to some embodiments of the invention. The flow diagram 500 is described with reference to FIGS. 1-3. The flow diagram 500 commences at block 502.

At block 502, the data storage and logic 114 receives data that is of a first data organization from a first data processor component. For example, with reference to FIG. 1, the variable length decoder 102 may generate macroblock packets 130 that are received by the data storage and logic 114. The output of the data may be of any of a number of different data organizations (including different block sizes and orders within such blocks as described in FIGS. 4A-4D above). With reference to FIG. 3, the data storage and logic 114 may receive the data through the registers 310. Control continues at block 504.

At block 504, (based on commands received on command channel 202/206 (see FIG. 2)) the data storage and logic 114 determines whether the first data organization is different from a native data organization for the next data processor component. The data storage and logic 114 may make this determination based on control information received. In particular, the command on the control channel 202/206 may specify the block size, pattern, etc. for the data being stored in the data storage and logic 114. With reference to FIG. 3, the data and storage logic 114 may receive the control information through the registers 310 (see also the command channel A 202 of FIG. 2). For example, the data and storage logic 114 may receive the data in a first order (such as that shown in FIG. 4A). However, the native data organization for the next data processor component may be that shown in FIG. 4B. Upon determining that the first data organization is not different from the native data organization, control continues at block 514, which is described in more detail below.

At block 506, upon determining that the first data organization is different from the native data organization, (based on commands received on command channel 202/206 (see FIG. 2)) the data storage and logic 114 determines whether the native data organization is based on a pattern that is stored in the pattern memory 224. With reference to FIG. 3, the data and storage logic 114 may make this determination based on control information received through the registers 310 or received from the control logic 314. Upon determining that the native data organization is not based on a pattern that is stored in the pattern memory, control continues at block 512, which is described in more detail below.

At block 508, upon determining that the native data organization is based on a pattern that is stored in the pattern memory 224, the data storage and logic 114 retrieves the pattern from the pattern memory 224. With reference to FIG. 3, the port A control logic 220 may retrieve the pattern from the pattern memory 224. Control continues at block 510.

At block 510, the data storage and logic 114 rearranges the data into the native data organization using the pattern that is stored in the pattern memory 224. With reference to FIG. 3, the port A control logic 220 may rearrange the data into the native data organization as the data is being retrieved from the registers 310; after the data is retrieved from the registers 310 and stored in the data buffer A 226 or the data buffer B 228, etc. For example, the port A control logic 220 may retrieve the data from the registers 310 that is different from the order that such data is stored therein. Control continues at block 514, which is described in more detail below.

At block 512, the data storage and logic 114 rearranges the data into the native data organization without using the pattern that is stored in the pattern memory 224. With reference to FIG. 3, the port A control logic 220 may rearrange the data into the native data organization as the data is being retrieved from the registers 310; after the data is retrieved from the registers 310 and stored in the data buffer A 226 or the data buffer B 228, etc. For example, the data organization may be a raster scan order for fixed sized blocks. Control continues at block 514.

At block 514, the data storage and logic 114 stores the data into the data buffer A 226 or the data buffer B 228 for subsequent retrieval by the next processor component. As described above, with reference to FIG. 3, the port A control logic 220 may store the data into the data buffer A 226 or the data buffer B 228. Control continues at block 516.

At block 516, the data storage and logic 114 retrieves the data from the data buffer A 226 or the data buffer B 228 for subsequent processing by the next processor component. With reference to FIG. 3, the port B control logic 220 may retrieve the data from the data buffer A 226 or the data buffer B 228. In some embodiments, the port B control logic 220 may retrieve the data in accordance with the pattern from the pattern memory 224 or in accordance with a given data organization type independent of a pattern from the pattern memory 224. The operations of the flow diagram 500 are complete.

Accordingly, as described, some embodiments allow for the logic that is part of the data storage to receive and rearrange the data into an organization that is native to the next processor component to process the data. Therefore, the next processor component may not be required to rearrange data that is not in accordance with a given order or type of data organization.

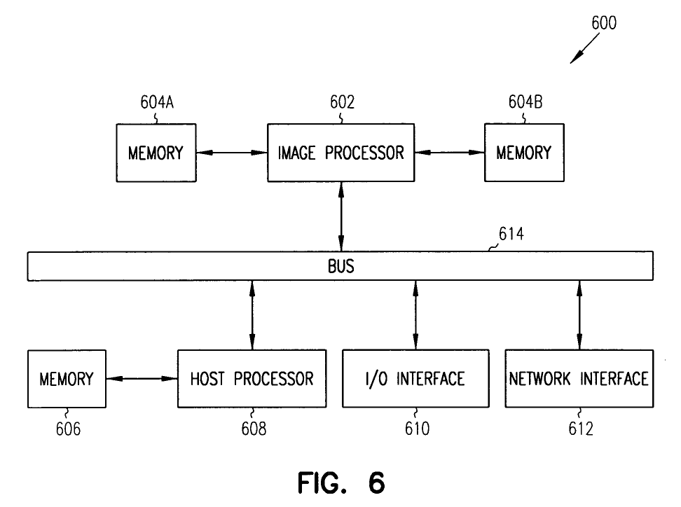

The data storage and logic described herein may operate in a number of different environments, according to some embodiments used to execute such operations is now described. In particular, FIG. 6 illustrates a processor architecture that includes the buffer architecture for data organization, according to some embodiments of the invention. FIG. 6 illustrates a system 600 that includes an image processor 602 that includes the buffer architecture for data organization, as described above. For example, the image processor 602 may include the components of the system 100 of FIG. 1.

The image processor 602 is coupled to memories 604A-604B. In some embodiments, the memories 604A-604B are different types of random access memory (RAM). For example, the memories 604A-604B are double data rate (DDR) Synchronous Dynamic RAM (SDRAM).

The image processor 602 is coupled to a bus 614, which in some embodiments, may be a Peripheral Component Interface (PCI) bus. The system 600 also includes a memory 606, a host processor 608, a number of input/output (I/O) interfaces 610 and a network interface 612. The host processor 608 is coupled to the memory 606. The memory 606 may be different types of RAM (e.g., Synchronous Dynamic RAM (SDRAM), DRAM, DDR-SDRAM, etc.), while in some embodiments, the host processor 608 may be different types of general purpose processors. The I/O interface 610 provides an interface to I/O devices or peripheral components for the system 600. The I/O interface 610 may comprise any suitable interface controllers to provide for any suitable communication link to different components of the system 600. The I/O interface 610 for some embodiments provides suitable arbitration and buffering for one of a number of interfaces.

For some embodiments, the I/O interface 610 provides an interface to one or more suitable integrated drive electronics (IDE) drives, such as a hard disk drive (HDD) or compact disc read only memory (CD ROM) drive for example, to store data and/or instructions, for example, one or more suitable universal serial bus (USB) devices through one or more USB ports, an audio coder/decoder (codec), and a modem codec. The I/O interface 610 for some embodiments also provides an interface to a keyboard, a mouse, one or more suitable devices, such as a printer for example, through one or more ports. The network interface 612 provides an interface to one or more remote devices over one of a number of communication networks (the Internet, an Intranet network, an Ethernet-based network, etc.).

The host processor 608, the I/O interfaces 610 and the network interface 612 are coupled together with the image processor 602 through the bus 614. Instructions executing within the host processor 608 may configure the image processor 602 for different types of image processing. For example, the host processor 608 may configure the different components of the image processor 602 for decoding operations therein. Such configuration may include the types of data organization to be input and output from the data storage and logic 114 (of FIG. 1), whether the pattern memory 224 is used, etc. In some embodiments, the encoded video data may be input through the network interface 612 for decoding by the components in the image processor 602.

In the description, numerous specific details are set forth. However, it is understood that embodiments of the invention may be practiced without these specific details. In other instances, well-known circuits, structures and techniques have not been shown in detail in order not to obscure the understanding of this description. Numerous specific details such as logic implementations, opcodes, ways of describing operands, resource partitioning/sharing/duplication implementations, types and interrelationships of system components, and logic partitioning/integration choices are set forth in order to provide a more thorough understanding of the inventive subject matter. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism that provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general-purpose or special-purpose processor, programmed with the instructions, to perform methods or processes of the embodiments of the invention. Alternatively, the features or operations of embodiments of the invention are performed by specific hardware components that contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for a buffer architecture for data organization, in accordance with some embodiments of the invention. A figure shows a flow diagram illustrating operations for a buffer architecture for data organization, in accordance with some embodiments of the invention. The operations of the flow diagram have been described with reference to the systems/apparatus shown in the block diagrams. However, it should be understood that the operations of the flow diagram could be performed by embodiments of systems and apparatus other than those discussed with reference to the block diagrams, and embodiments discussed with reference to the systems/apparatus could perform operations different than those discussed with reference to the flow diagram.

In view of the wide variety of permutations to the embodiments described herein, this detailed description is intended to be illustrative only, and should not be taken as limiting the scope of the inventive subject matter. What is claimed, therefore, are all such modifications as may come within the scope and spirit of the following claims and equivalents thereto. Therefore, the specification and drawings are to be regarded in an illustrative rather than a restrictive sense.

What is claimed is:

1. An apparatus comprising:
a first data processor component to output data in a first data organization; and
a data storage logic to receive the data output from the first data processor component, the data storage logic to rearrange the data into a second data organization prior to storage of the data into a data storage, wherein the second data organization is a native format of a second data processor component to subsequently process the data.

2. The apparatus of claim 1, wherein the first data organization includes a different order of storage of the data in comparison to the second data organization.

3. The apparatus of claim 2, wherein the different order is a row wise pattern, a column wise pattern or a zigzag pattern.

4. The apparatus of claim 2, wherein the different order of storage includes a number of different blocks of one or more sizes, wherein the number of different blocks are of an order that is a row wise pattern, a column wise pattern or a zigzag pattern.

5. The apparatus of claim 2, wherein the data storage is to store a data pattern and wherein the different order is based on the data pattern.

6. The apparatus of claim 1, wherein the data comprises one or more frames of video pixels.

7. A system comprising:
a first memory;
a variable length decoder to decode a compressed bit stream and to output macroblock packets in a first data organization;
a first data storage logic to reorder bits of the macroblock packets into a second data organization, wherein the first data storage logic is to store the bits of the macroblock packets into the first memory; and
a run level decoder to retrieve the bits of the macroblock packets from the memory and to generate coefficient data based on the bits of the macroblock packets, wherein a native data organization of the run level decoder is the second data organization.

8. The system of claim 7, wherein the first data organization includes a different order of storage of the data in comparison to the second data organization.

9. The system of claim 8, wherein the different order is a row wise pattern, a column wise pattern or a zigzag pattern.

10. The system of claim 8, wherein the different order of storage includes a number of different blocks of one or more sizes, wherein the number of different blocks are of an order that is a row wise pattern, a column wise pattern or a zigzag pattern.

11. The system of claim 7, wherein a pattern is to be stored in the first memory, wherein the first data organization is based on the pattern.

12. The system of claim 7, further comprising:
a second memory;
a second data storage logic to reorder bits of the coefficient data into a third data organization, wherein the second data storage logic is to store the bits of the coefficient data into the second memory; and
a Discrete Cosine Transform (DCT) logic to retrieve the bits of the coefficient data, wherein a native data organization of the DCT logic is the third data organization.

13. The system of claim 12, wherein a pattern is to be stored in the second memory, wherein the third data organization is based on the pattern.

14. The system of claim 7, wherein the compressed bit stream comprises one or more frames of video pixels.

15. A method comprising:
receiving data that is based on a first data arrangement from a first data processor;
rearranging the data into a native data arrangement for a second data processor, wherein the second data processor is a next processor to process the data; and
storing the data into a data storage.

16. The method of claim 15, wherein the operations further comprise,
retrieving the data from the data storage; and
transmitting the data to the second data processor.

17. The method of claim 15, wherein rearranging the data into the native data arrangement comprises performing the following operations if a pattern from the data storage is used in the rearranging of the data into the native data arrangement:
retrieving a pattern from a pattern memory; and
rearranging the data into the native data arrangement based at least in part on the pattern.

18. The method of claim 17, wherein the pattern comprises multiple blocks and an order of data in the multiple blocks.

19. The method of claim 18, wherein the order of data in the multiple blocks is a row wise pattern, a column wise pattern or a zigzag pattern.

20. The method of claim 15, wherein the data comprises one or more frames of video pixels.
